(19) United States
(12) Patent Application Publication
(10) Pub. No.: US 2008/0069065 A1
(43) Pub. Date: Mar. 20, 2008

(54) Method of seamlessly roaming between multiple wireless networks using a single wireless network adaptor

(75) Inventors: Wai Keung Wu, Hong Kong (HK); Tun Han Felix Lo, Hong Kong (HK)

Correspondence Address: WELLS ST. JOHN P.S., 601 W. FIRST AVENUE, SUITE 1300, SPOKANE, WA, 99201, US

(73) Assignee: Hong Kong Applied Science and Technology Research Institute Company Limited, Hong Kong (HK)

(21) Appl. No.: 11/524,766

(22) Filed: Sep. 20, 2006

(51) Int. Cl. H04Q 7/28

(52) U.S. Cl. 370/340

(57) ABSTRACT

A method of roaming between access points on the same or different wireless networks using a single wireless network interface adaptor. A device will establish a connection with a second wireless network access point while still connected with a first wireless network access point such that the device can concurrently communicate with both wireless access points. During and after connection with the second wireless network access point real-time IP data transfer is maintained with another network device by switching between the first and second access points for concurrently sending and receiving data packets via both access points using a switching strategy based at least in part on a number of the data packets to be send to each network access point. The method also determines when to roam, scans for candidate wireless network access points to connect to and selects the best access point for roaming based on selection criteria.

### BACKGROUND TO THE INVENTION

1. Field of the Invention

The invention relates to a method of seamlessly roaming between multiple wireless networks, and/or network access points, using a single wireless network adaptor. In particular the invention relates to such a method that can seamlessly maintain real-time IP data transmission, for example in an IP telephony service, while roaming between multiple wireless networks and/or network access points.

2. Background Information

Voice over Internet Protocol (VoIP) is a method of allowing telephone calls to be made over conventional internet connections. In VoIP systems a call is established with another party and call information sent as discrete data packets over the internet using a real-time transmission protocol. A number of internet based IP telephony service providers have established themselves, such as SIPphone, VONAGE and Skype, and the service is becoming increasingly popular as a cost effective voice communication mean. Originally calls would be placed between computers hardwired to the internet. However, with the development and deployment of wireless networking and the proliferation of wireless network ‘hotspots’ throughout homes, offices, social venues and cities the use of wireless IP phones is becoming increasing popular. A number of major manufacturers are now producing wireless IP phones including as Cisco, Hitachi, Motorola and others.

A problem with wireless IP telephony services is that typical wireless network access points (APs) have a very short range. If the user of a wireless IP phone wants to move any distance during a call the phone will be required to roam over adjacent APs connected to the same or different wireless networks. During roaming the wireless IP phone must connect to two APs simultaneously to maintain the call on the original AP while authenticating with the new AP and initiating transfer of the call to its new IP address and port on the new wireless network.

Hitherto, the IEEE 802.11 community has devoted much to shortening the time for hand-off between APs belonging to the same Extended Service Set Identifier (ESSID) and the same subnets, such as 802.11k and 802.11r. However, there is no good mechanism for roaming across AP's belonging to different ESSID's and/or different subnets. The evolving 802.11u standard offers a solution to this issue, but it requires all the networking equipments to be upgraded and does not solve the issue for disjoint networks. Other solutions require integration in the backbone network, such as DHCP Relay or other context transfers mechanism, but such integrations are often undesirable in practical deployment scenario. A client-only solution is thus very desirable. One possible client-only solution is to utilize two wireless network adapters within the wireless IP phone. During roaming the wireless IP phone uses the secondary wireless network adapter to configure and connect to the target roaming network before hand-off to the new network. Once the new network is ready, the wireless IP phone can initiating transfer of the call to its new IP address and port on the new wireless network. Inclusion of two wireless network interface adapters into a handheld wireless devices is problematic for various reasons including size of the device, power consumption, and, most significantly, BOM cost and expense.

Within the last few years advances have been made which permit access to multiple wireless networks with a single wireless interface adaptor. However, because traditional wireless networking is designed for business applications or general internet surfing, neither of which are typically real-time applications, current methods of roaming between multiple networks using a single wireless adaptor are unsuitable for IP telephony.

One such system has been proposed by Ranveer Chandra, Paramvir Bahl, Pradeep Bahl in Multinet: Connecting to Multiple IEEE 802.11 Network Using a Single Wireless Adapter, IEEE Infocom 2004 (a copy of this paper is available at http://research.microsoft.com/˜bahl/MS_Projects/-MultiNet/infocom.pdf or http://www.ieee-infocom.org/2004/Papers/18_{—}3.pdf) and US patent application publications 2004/0218580 and 2005/0063328, which are incorporated herein by reference. In the system proposed by Chandra et al virtual network interfaces are achieved by a virtual wireless LAN driver inserted into the network stack between the application and transport, or host, layers and the data and physical, or media, layers. The application and transport layers see multiple active network interfaces while the data and physical layers see only one active network interface. However, at each switching between APs is accompanied by the transmission and reception of Authentication/Association Request and Responses, which causes queued packets to be dropped in a large number of commercial APs (but not all). Chandra et al solution is also accompanied by scanning (probe requests and responses) which cause a large delay.

### SUMMARY OF THE INVENTION

Accordingly, is an object of the present invention to provide a method of seamlessly roaming between multiple wireless networks using a single wireless network interface adaptor for use with wireless roaming in real-time communication environments.

In view of the foregoing, there is disclosed herein a method of seamlessly roaming between multiple wireless local area networks (WLANs) using a single wireless network interface adaptor having one or more of the following aspects, which are not exhaustive nor intended to limit the scope of the appended claims.

An adaptive channel scanning scheme using passive scanning to retrieve signal strength through beacons in the same channel as the associated access point without any effect on data transmission. A threshold signal strength is used to trigger an active scanning regime wherein wireless channels are probed separately with periods of data transmission there between, and the results stored in a list of roaming target candidates.

In the list of roaming target candidates each network interface corresponds to a channel with a list of roaming target candidates, instead of to each roaming candidate requiring an interface. This reduces the number of interfaces necessary if there is more than one potential roaming candidate.

A dynamic jitter buffer is used in the seamless roaming handover in which when the handover process begins, the jitter buffer size is increased to the minimum required size for the roaming and the playback of media is adjusted to a slower rate carefully regulated to be unnoticeable by humans. After the handover process is completed the jitter buffer size is dropped back to the original size and the playback of media periodically adjusted at a faster rate carefully regulated to be unnoticeable by humans before being returned to its normal rate.

The invention manages two network interfaces with only one wireless network interface adaptor by one or more switching schemes between the networks including use of periodic Power-save Mode Poll (PS-Poll) messages, switching between networks based on a network weighting, in which the physical interface spends more time on one virtual interface than the other virtual interface to account for different levels of traffic on the two interfaces and/or switching between networks based on a correlation between buffered packets and a time spent on the particular virtual interface.

Further aspects of the invention will become apparent from the following description and the claims.

### BRIEF DESCRIPTION OF THE DRAWINGS

An exemplary form of the present invention will now be described by way of example only and with reference to the accompanying drawings, in which:

FIG. 1 is a schematic overview of the exemplary environment in which the invention is practiced,

FIG. 2 is a flow diagram of an exemplary method of carrying out aspects of the invention,

FIG. 3 is a schematic illustration of basic packet flow over networks in the exemplary method,

FIG. 4 is a schematic illustration of network drivers for facilitating multiple virtual network interfaces using a single wireless network interface adaptor,

FIG. 5 is a schematic illustration of a scheme for active scanning wireless networking channels for available wireless network access points,

FIG. 6 is a schematic illustration in greater detail of packet flow over networks in the exemplary method,

FIG. 7 is a schematic illustration a time sharing arrangements for the two virtual network interfaces using a single wireless network interface adaptor,

FIG. 8 is a schematic illustration of packet delay in the exemplary method, and

FIG. 9 is a schematic illustration of basic packet flow over networks when the exemplary method is practiced with a SIP B2BUA server for firewall or NAT traversal.

### DESCRIPTION OF THE EXEMPLARY EMBODIMENTS

The current invention provides for a method of seamlessly roaming between multiple wireless local area networks (WLANs) using a single wireless network interface adaptor. In the specification the terms wireless network interface adapter, network adaptor, Wi-Fi adaptor and the like refer to a card or built-in hardware used to connect a computer or handheld device to a network, either wired or wireless as the context requires.

The invention will be described as practiced in a portable device that allows wireless connection to an internet based IP telephony service. Such a device may be a wireless IP phone that allows connection to the internet without a computer, or soft-phone software operating on a wireless portable computer or other device such as a PDA. IP telephony services use real-time internet protocols such as RTP to transmit audio or other multimedia content in discrete packets between users of IP phones or soft-phones in different locations or from an internet based IP phones or soft-phone to a phone connected to a public switched telephone network through a gateway. Those skilled in the art will appreciate that aspects of the invention may be practiced with other devices or computer systems that need to connect quasi-simultaneously to multiple WLANs or to roam between WLANs while maintaining a real-time connection to another device or computer in another part of the network or via the internet.

The exemplary embodiment of the invention is also described as practiced in a wireless environment based on the IEEE 802.11 standard, common referred to as a wireless fidelity or Wi-Fi network, and uses functionality provided for in that standard. This is not however intended to limit the scope of use or functionality of the invention. There are many other wireless networking standards such as Bluetooth, Wireless 1394, Hiperlan, Hiperlan/2, HomeRF, OpenAir and others. The skilled artisan will also appreciate that similar functionality may be available now or in the future or can otherwise be implemented in other current or future wireless networking standards. It is envisaged, for example, that as the popularity of Voice over Internet Protocol (VoIP) multimedia communication services increases wireless networking standards may be modified or developed to cater specifically for real-time communication system roaming requirements.

The exemplary embodiment of the invention uses the Session Initiation Protocol (SIP) Real-time Transport Protocol (RTP) for VoIP and also uses functionality provided for in that standard. This is also not intended to limit the scope of use or functionality of the invention. Similar functionality is also available in the Media Gateway Control Protocol (H.323) and other real-time IP standards. Again, it is envisaged that as the popularity of VoIP multimedia communications increases other real-time protocols may become available in which the invention can be practiced.

In the described exemplary embodiment of the invention functionality and procedures from IEEE 802.11 and SIPs are discussed and used. It is understood that these are well established public standards and full knowledge, functionality and use of the methods provided for within these standards is within the purview of those skilled in the art. A detailed description of any IEEE 802.11 and SIP methods is not necessary and not given.

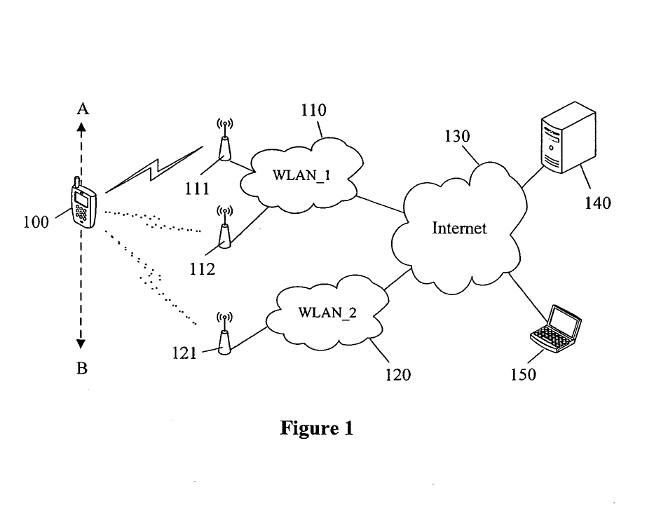

FIG. 1 gives a schematic overview of the exemplary environment in which the invention is practiced. Components of the system include, but are not limited to, a Wi-Fi enabled IP phone 100, two wireless local area networks (WLANs) 110 120 each connected to the internet 130 and an IP telephony service provider 140. The internet telephone service provider 140 uses the SIP protocol and includes SIP proxy, redirect and/or Back-to-Back User Agent (B2BUA) servers as necessary. The first WLAN 110 has two wireless access points (APs) 111 112 which share the same Extended Service Set Identifier (ESSID) of first WLAN 110. The second WLAN 120 has a single AP 121 having the ESSID of second WLAN 120. The IP phone 100 has a single wireless network interface adaptor for communication with the WLANs 110 120. WLAN 110 and WLAN 120 are possibly disjoint networks, but may also be part of a public or private wide area network (WAN). The IP phone 100 has a single wireless network interface adapter for communication with the WLANs 110 120.

In the exemplary environment of FIG. 11P phone 100 is associated with AP 111 of WLAN 110 and places a SIP initiated VoIP call to another IP phone user 150. The call is established as known via SIP proxy and/or redirect servers of the IP telephony service provider 140 to establish a real-time RTP packet stream between User Agents (UAs) of the two IP phones 100 150. If the user of wireless IP phone 100 moves through the exemplary environment from location A to location B the IP phone 100 must change WLAN connection points from first AP 111 to, say, second AP 112 of first WLAN 110 and then to AP 121 of second WLAN 120. The current invention provides for a seamless roaming between the APs that is substantially undetectable by the user. The invention achieves this seamless roaming using a single wireless network interface adaptor by providing software routines, drivers, objects and components that are incorporate into the IP phone 100. The software routines, drivers, objects and components enable the IP phone 100 to determine when to roam between AP connections, to scan AP signals in its vicinity and to determine a suitable roaming candidate AP/WLAN, to dynamically adjust the phone jitter buffer size and playback to maintain smooth playback during roaming, to dynamically create and manage multiple virtual networks interfaces using a single wireless network interface for associating with multiple APs quasi-simultaneously and to redirect the internet call (i.e. the RTP packet stream) is through the new AP.

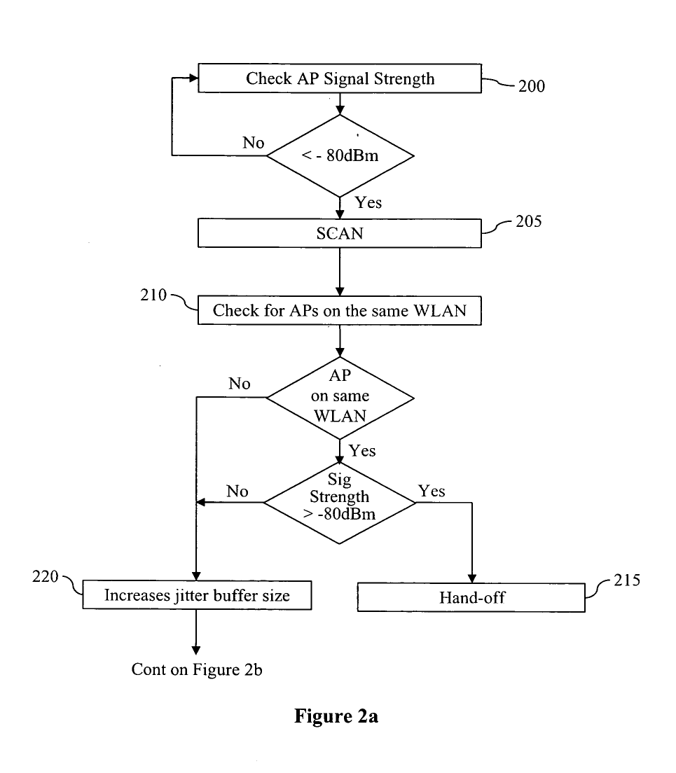

FIG. 2 show in more detail the steps performed by the software routines, drivers, objects and components in implementing the invention in the roaming IP phone 100. In the initial step 200 the IP phone 100 monitors the signal strength of the currently associated AP (111). Most Wi-Fi adaptors allow passive acquisition of an associated AP's signal strength through the beacon while maintaining active data transmission with the AP. When the signal strength of AP 111 falls below a threshold, which in the exemplary embodiment is −80 dbm, the IP phone 100 enters the scan step 205 and scans the environment to identify target roaming network APs. The IP phone 100 building a roaming list of target roaming APs in range of the IP phone 100. In the exemplary environment the target roaming APs are AP 112 of WLAN 110 and AP 121 of WLAN 120.

The IEEE 802.11 standard covers only a single WLAN network. It violates the IEEE standard for one client (e.g. IP phone 100) associated with two APs belonging to the same network because, for example, it would be unclear whether a packet from the network targeted at the client should go through the first AP or the second AP. APs 111 and 112 of the exemplary environment belong to the same network and so IP phone 100 cannot simultaneously associated with both APs 111 and 112 for seamless roaming according to the current invention. Therefore, the next step 210 and is to check all APs in the roaming list to determine whether they belong to the same WLAN as the currently associated AP. One way to do this is to use IEEE 802.11i pre-authentication in which the IP-phone 100 sends a pre-authentication request through the currently associated AP 111 to each AP in the roaming list (in the present case is AP 112 and AP 121). Only APs belonging to the same network or subnet, in this case AP 112, will hear the pre-authentication request and respond. If no response is received to the pre-authentication request then it is assumed that the AP is on a different network or subnet and is it ok to roam to it. More generally, determining whether an APs in the roaming list can be done using any general packet sent to that AP as long as the packet has (1) as its immediate destination the currently associated AP, (2) as its final destination the AP in the roaming list being checked and (3) that the AP being checked will give some response back through the currently associated AP to the IP-phone 100.

The inventors do not believe that it violates the IEEE standard to simultaneously associate with two APs on a different subnet of the same network. For example, a one AP may be on a first subnet 10.1.2.xxx and a second AP may be on a second subnet 10.8.132.xxx or the same network. Routing between these two subnets takes place at the layer 3 router level instead of a layer 2 switch level and so conceptually two subnets can be considered as two independent networks under IEEE 802.11. For the purpose of the current explanation though it is assumed that APs 111 and 112 are within the same subnet.

The decision of which AP to roam to can be based on fixed or adaptive criteria such as signal strength of the APs, the rate of change of signal strength (which is an indicator of speed of movement of the IP phone 100), a list of preferred APs/WLANs (e.g. BSSID or ESSID) stored with the IP phone memory or the amount of traffic on the AP or WLAN. In the exemplary embodiment the decision is based on highest signal strength with a threshold value of −80 dbm, with APs with the same network or subnet as the current AP have preference. Thus, in the present case if AP 112, which is on the same WLAN, has a signal strength greater than −80 dBm it will have roaming preference. In this case simultaneous association with APs 111 and 112 would violate IEEE 802.11, but is also unnecessary. The IEEE 802.11i standard provides for hand-off between APs belonging to the same Extended Service Set Identifier (ESSID) and the same subnets. Using these protocols IP phone 100 simply hand-off communication to AP 112 once pre-authentication is complete (step 215). Pre-authentication may be done in step 210 when checking if the AP is on the same WLAN or subnet. Because pre-authentication with AP 112 is achieved while connected with AP 111 real-time data transfer is not materially affected by the hand off.

For the purpose of describing the seamless roaming of the current invention it is assumed that the signal strength of AP 111 and AP 112 are both below −80 dBm and so roaming must occur between AP 111 and AP 121, which are on different WLANs. During this roaming process, as will become apparent later, the IP phone 100 will have the original AP 111 periodically buffer the real-time protocol (RTP) data packets containing, amongst other things, call audio content. To accommodate the delay in packet delivery without detection by the user the first roaming step 220 is to dynamically increase the size of the playback jitter buffer to its maximum value and to marginally slow down audio playback by an amount that is generally undetectable in normal listening. This allows the phone 100 to buffer additional audio information for playback when RTP packets are being buffered by an AP and not received.

Turning to step 230, the invention then provides for the creation of virtual network interfaces in the phone for simultaneous association with current AP 111 and target AP 121. The current invention uses a variation on the method proposed by Chandra et al described earlier. Chandra et al use virtual drivers inserted in to network stack to simulate multiple network interfaces. However, each switch between networks is accompanied by transmission and reception of Authentication/Association Request and Responses. Therefore, the system proposed by Chandra et al is not a simultaneous association with multiple APs. Furthermore, the inventors tested a large number of APs and discovered that most clear out packets previously buffered for a wireless node upon receipt of an Authentication/Association Request from that node. Buffering of packets at the AP is used by the current invention and so Authentication/Association Requests cannot not be used when switching back and forth between APs in the current invention.

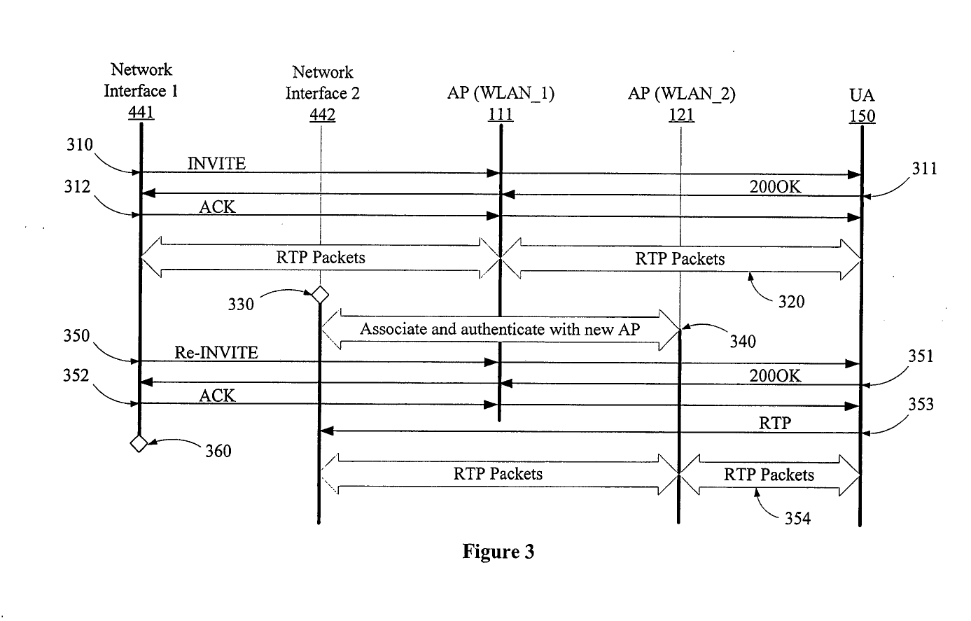

Referring briefly to FIG. 4, the applicant's method utilizes virtual drivers 410, 420 that sit on top of the proprietary driver 430 provided by the manufacturer/vendor of the network adaptor 440. The virtual drivers 410, 420 act as an interface between the application and transport layers and the proprietary driver 430 to simulate multiple active network interfaces 441, 442. A list is maintained of each AP and its states for each virtual interface 441 442. To switch between APs the virtual drivers 410, 420 switch states in the proprietary driver 430 so that the network interface adapter 440 is switched to the state of the desired AP without sending any Authentication Association Request.

Having established multiple network interfaces we move to the next steps 240-270 which are to associate with the new AP 121, authenticate with any security system, e.g. WPA etc, implemented in the AP, get an IP address for the interface and trigger STUN or TURN server requests to obtain a public IP address for network address translation (NAT) or router traversal if required. These steps are well known in the art and details need not be given.

In step 280 the invention provides for the IP phone 100 to initiate a redirect of the RTP packet stream to its new IP address on second WLAN 120. In the exemplified embodiment this is done by sending a SIP re-INVITE message. The SIP protocol allows an INVITE to be sent during a current call stream to modify the dialog and parameters of the stream. An INVITE request sent within an existing call is known as a re-INVITE. After a re-INVITE is received by the other party's UA and acknowledgements dealt with further RTP packets will be sent to the new IP address contained in the re-INVITE message. When the RTP packets are received through the new virtual network interface step 290 is to disassociate with the old AP 111 and delete its virtual network interface. The final step 231 provided by the invention is to marginally speed up audio playback by an amount that is generally undetectable in normal listening. This will empty the jitter buffer which can then be reduced to it nominal operating size.

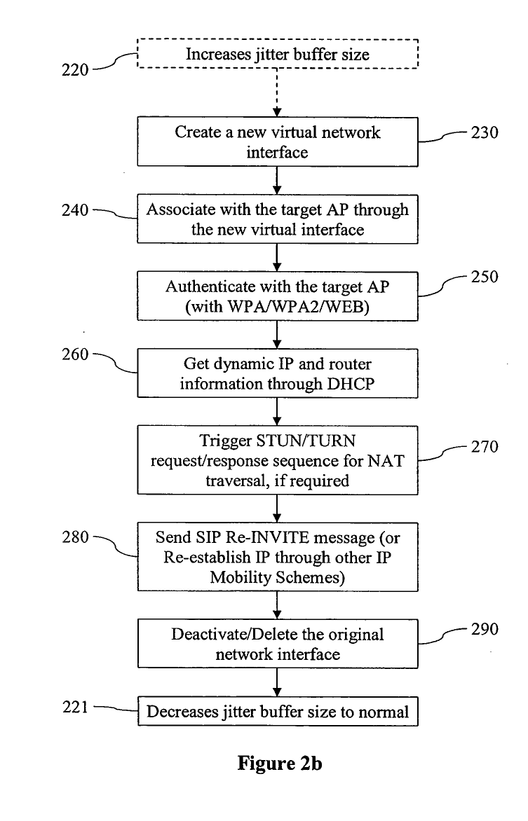

The basic data packet flow in the above method is schematically illustrated in FIG. 3. In the SIPs environment a call is placed from IP phone 100 to another IP phone user 150. The IP phone application sends an INVITE message 310 which is routed via a SIP proxy or redirect server in 140 to the UA of the other party 150. For simplicity the SIP proxy and/or redirect servers are not illustrated in FIG. 3. The other party's UA 150 replies with a 200OK message 311 which is acknowledged by the IP phone 100 with an Acknowledgment message 312. The call RTP packet stream 320 is established. When the decision is made to roam to another WLAN a new virtual network interface 442 is created within the phone 100 network stack. Using this new interface 442 packets 340 are sent/received in known manner to associate and authenticate with the new AP 121 as set out in IEEE 802.11 and obtain an IP address on WLAN 120. Once the new network connection is established a re-INVITE message 350 is sent form the original interface 441 to the other UA 150. The re-INVITE message 350 includes a contact header holding the new IP address and the SDP indicating the new IP address and port for listening for RTP packets after roaming. After the re-INVITE message 350 the other UA 150 and IP phone 100 exchange 200OK and acknowledgement messages 351 352. The phone 100 switches periodically between original interface 441 and new interface 442 and listens for the first RTP packet 353 to that address. When it is received the original network interface 441 is deactivated 360 and the call RTP packet stream 354 continues through the new network interface 442.

Certain aspects of the invention will now be described in more detail. The essence of the following discussion is to provide criteria for seamlessly roaming between two APs and/or WLANs. Two measurements can be used as indicators of how seamless roaming is. These are the number of RTP packets dropped during the procedure and the mount of jitter delay induced by the procedure. Target values established by the inventors are a maximum of 1 to 2 packets dropped and 60 ms to 120 ms jitter delay.

Auto-scanning utilities and methods provided with most wireless network interface adaptors are not intended to solve the seamless roaming problem, but rather are intended to scan and roam a mobile device from one AP to another AP with the simple aim of maintaining a TCP connection. Real-time communications are not considered. Depending on the configuration as specified by IEEE 802.11 the delay of the scanning method can range from 500 ms up to 3 to 5 seconds. The delay results form several factors including the association and authentication procedure for each AP which is usually around 3 ms to 5 ms, the preparation time before each probe which may be up to 200 ms and the accumulated time for each channel probed. For example, if the probe delay is 50 ms, the preparation time is 100 ms both before and after all eleven channels are probed then the delay will be 100+(50×11)+5+100=755 ms. This would result in an unacceptable large jitter buffer or number of dropped packets and possibly a detectable break in the audio playback.

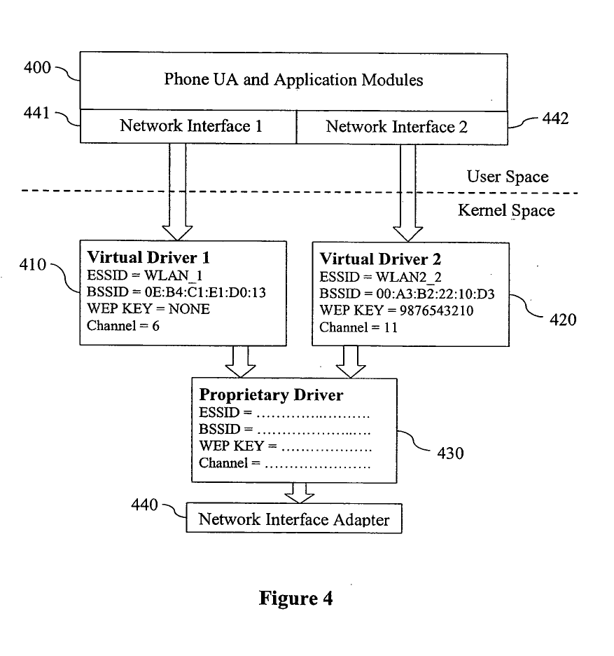

One method of scanning for available wireless networks is to intersperse a series of short discrete probes between periods of data transmission. This scheme is illustrated in FIG. 5. Each channel is probed separately with the normal transmission and reception of data packets between probes. During each discrete probe a probe request 500, 501, 502, 503 is sent out on the selected channel 1, 6, 11, . . . , n. All APs on that channel, regardless of BSSID/ESSID, that hear the probe request should send a probe response from which their signal strength and identifying information is obtained. After sending the probe the wireless adaptor listens on the probed channel for a short period 510, 511, 512 of, say, 50 ms for any probe response. The phone then switches to normal transmission/reception mode 520, 521, 522, for a short period of, say, 100 ms before making the next probe request on another channel. After each probe request information about responding APs is entered into a roaming list.

Referring to FIG. 4, multiple quasi-simultaneous network connections are achieved by virtual wireless LAN drivers 410, 420 inserted into the network stack between the application and transport layers and the data and physical media layers. The virtual wireless LAN drivers 410, 420 simulate multiple virtual wireless network interfaces 441 and 442. Modules in the application layer 400, such as the UA (SIP user agent), phone applications and session and transport modules, see multiple active network interfaces 441 and 442 at all times whereas the data and physical layers see only one active network at a time. The technique is described as allowing quasi-simultaneous network connections because in reality only one physical connection is possible at one time, but it is manipulated by the virtual drivers 410, 420 and other modules of the invention to appear to upper level network layers as simultaneous network connections.

Actual communication with the network interface adapter 440 is still achieved by the proprietary driver 430 provided by the device manufacturer. The proprietary driver 430 acts as a slave to the virtual drivers 410, 420. The virtual drivers 410, 420 maintain AP and WLAN connection parameters such as BSSID, ESSID, channel, WEP key, WPA key, WPA information element, IP address etc for each virtual network interface 441 442. These connection parameters are switched to the proprietary driver 430 so that its connection parameters match that of the currently active virtual network interface. No Authentication/Association Request and Responses are sent when switching between APs/WLANs.

The virtual wireless LAN drivers 410, 420 are also responsible for buffering packets sent by the UA and other applications over a virtual network interface that is not active. When the network interface becomes active the buffered packets will be sent first. Buffering of incoming packets for a non-active network interface is done at the AP. This is achieved using the IEEE 802.11 standard Power-save Mode which instructs APs to buffer packets for the wireless device. IEEE 802.11 Power-save Mode is turned on, all outgoing transmitted packets will have a flag indicating that the phone 100 network adapter is sleeping. If no data packets are sent by the UA or other phone applications the virtual driver will send a null-packet so that the AP knows that the phone 100 will be sleeping. Of course, the phone 100 will not be sleeping, but will be connected with the other associated AP. The invention maintains real-time data transfer for the telephone call by dynamically switching between network interfaces based on the number of buffered outgoing packets to be sent as well as using the Power-save Mode Poll (PS-Poll) function in IEEE 802.11.

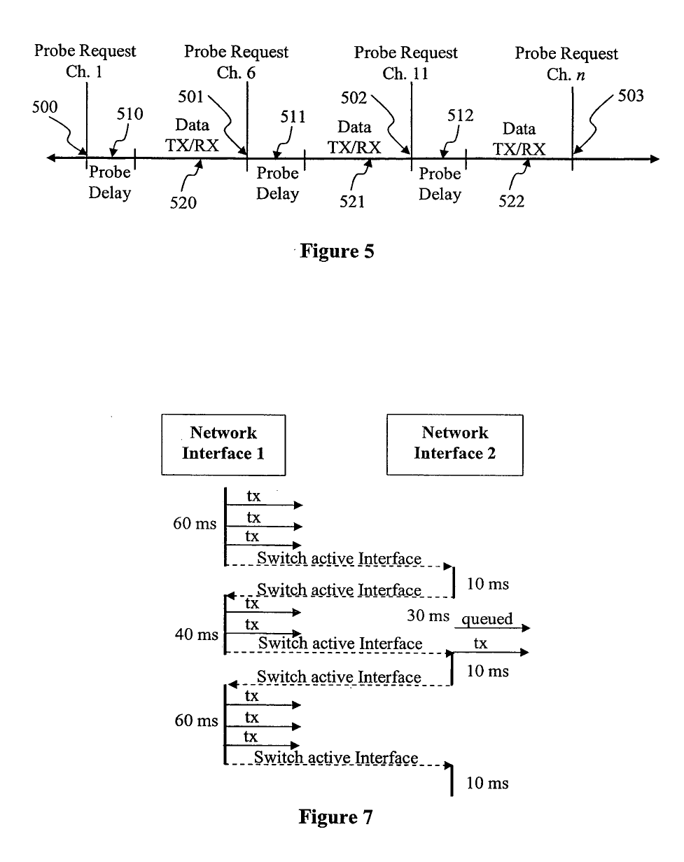

FIG. 6 illustrates packet flow in the invention utilizing IEEE 802.11 Power-save Mode and PS-Poll functions. Prior to the decision to roam the IP phone 100 is exchanging RTP packets 320 via network interface 441 with the called party's UA 150. A procedure 330 creates a second virtual network interface 442 and the phone sends a Power-save Mode message via network interface 441 to AP 111. AP 111 will buffer packets 620 intended for network interface 441 in accordance with the IEEE 802.11 specification. The phone application can then switch the virtual interface to new interface 442 and begin the association and authentication procedure 340 with AP 121 of WLAN_2 120. Although the phone 100 is no longer exchanging RTP packets with called party 150 this is indistinguishable to the user because the dynamically expanded jitter buffer allows continued playback of audio from the called party 150 and outgoing packets are being buffered by the network driver 410 for sending when network interface 421 is made active.

Connection with AP 111 must be re-established periodically in order to refill the jitter buffer and maintain the seamless and undetectable nature of the roam. The AP 111 will periodically send a beacon to the phone on network interface 441 indicating that packets are being buffered for delivery to it. One option in the roaming scheme is to periodically switch between network interfaces 442 and 441 to listen for beacons from AP 111. However, because the phone is in a call with the other party 150 we know that packets are being buffered at the AP 111. Therefore, we can choose a simple connection swapping scheme to periodically send PS-Poll messages to the AP 111 to have the buffered messages forwarded without waiting for its beacon. Even if the AP has not buffer any packets for delivery sending a PS-Poll message does not violate the IEEE 802.11 standard.

In alternative embodiments, instead of using the PS-Poll message the IP phone 100 can send a message to the AP indicating that it has turned-off Power-save Mode. All queued packets will be sent by the AP. In another alternative embodiment the Power-save Mode scheme in the new IEEE 802.11e standard is used. The IEEE 802.11e standard defines a set of Quality of Service enhancements for LAN applications that are useful in delay-sensitive applications such as VoIP and Streaming Multimedia. The Power-save Mode scheme in the IEEE 802.11e standard is conceptually similar to that described but uses different packets to retrieve the data and should be more efficient.

The phone 100 switches between network interfaces periodically to the original interfaces 441 and sends a PS-Poll message 610, 611, 612. Before switching the phone 100 sends a Power-save Mode message to AP 121 to have packets buffered at that AP. The phone will remain on the original interface 441 for a period of time for buffered packets to be delivered and to send queued outgoing packets. It is envisaged that traffic on the new interface 442 will be lighter that on the original interface 441. The phone will switch between interfaces as many time as is needed to complete the roaming of the call, which may include communication 630 with a STUN or TURN server for NAT traversal. Finally, once the re-INVITE sequence 350-352 has been completed and RTP packets 353-354 are delivered to the new network interface 442 the original network interface 441 can be deactivated 360.

Of importance to seamless roaming is choosing the time period between switching of interfaces 441 442 for continuing the call on the original interface 441 while establishing the connection and call on the new interface 442. One method is just to select a fixed time period of, say, 10 ms or 20 ms for switching between interfaces. However, this does not take into account the amount of traffic on each interface and a better method is to configure the switching time to be weighted between the two network interfaces 442 and 441 based on traffic. As indicated, typically there will be more traffic on the original interface 441 which is handling the VoIP call and less traffic on the new interface 441. One weighting scheme therefore is to apply a heavier weighting to the original interface 441 handling the VoIP call. This can be termed the primary interface and allocated 100 ms of active time in each switching cycle. The phone need only remain on the new, or secondary, interface for a short period, say, 10 ms and can then switch back to the primary interface for another 100 ms. The phone will continue this 100 ms/10 ms switching cycle until the RTP stream is being delivered to the new interface 442. However, a better scheme still and the one used in the preferred embodiment of the invention, is to dynamically allocate switching time based on pending outgoing traffic on either network interface 441 442.

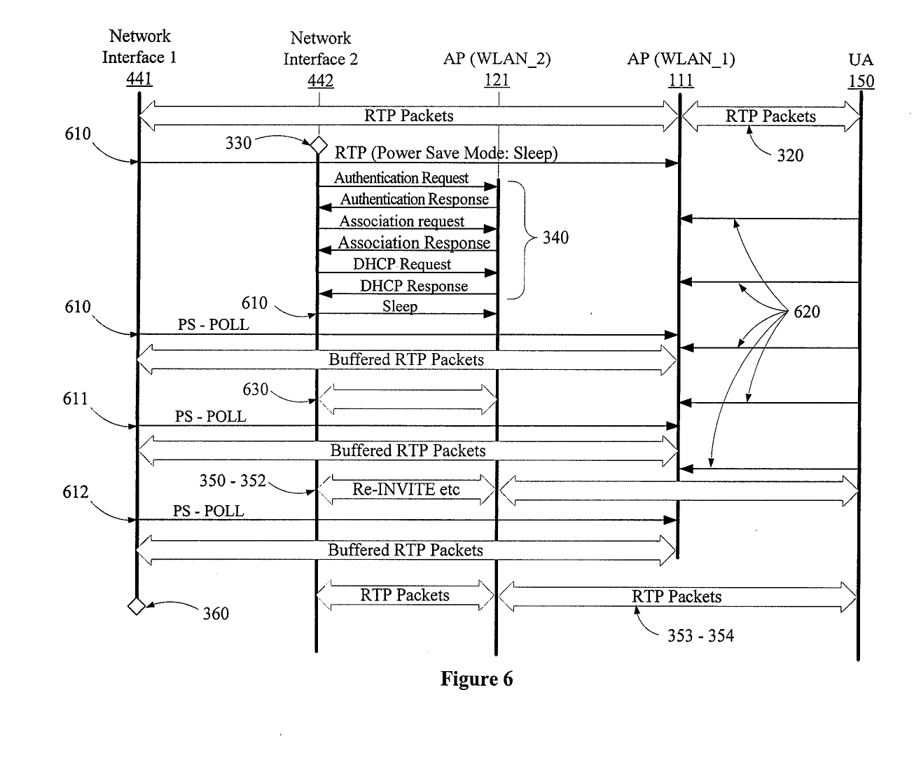

Referring to FIG. 7 a dynamic allocation scheme of switching interfaces is shown. This is based on two rules and a minimum and maximum time to remain on an interface. The first rule states that when a packet is queued to be transmitted in the inactive interface the phone will wait the minimum time and then switch interfaces to send the packet. The second rule states that when there is no packet queue up waiting to be transmitted in the inactive interface the phone will wait for the maximum time and then switch interfaces. In the preferred embodiment the minimum time is 10 ms and the maximum time is 60 ms. The advantage of this scheme is that outgoing packets, such as association or authentication request packets, will get transmitted immediately instead of waiting for a significant amount of time to get send out. Measurement by the inventors indicates that a minimum time of 10 ms and a maximum time of between 60 ms and 100 ms yields good performance in seamless roaming. The jitter delay required for incoming/outgoing RTP packets using this dynamic allocation is between 60 ms and 100 ms.

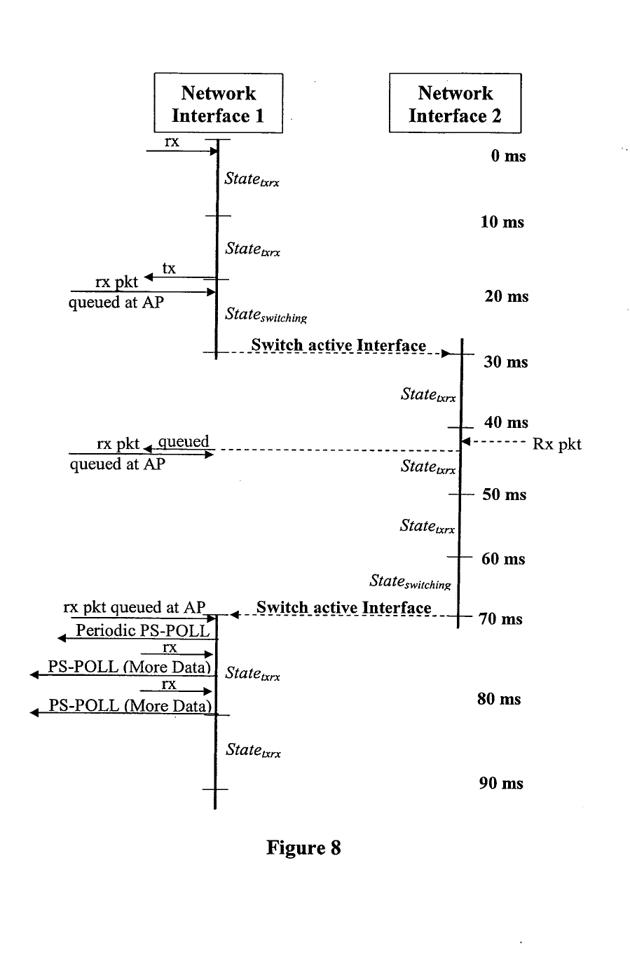

FIG. 8 describes the events in which the RTP stream would see a maximum delay. Turning to FIG. 8, we want to predict the maximum delay for RTP packets that arrive at one interface, say 441, with the other interface sending packets periodically, such as DHCP, STUN, TURN, WPA, etc, say 442. We must make the following assumptions.
Interval between RTP packets is set 20 ms;
1 jiffy=10 ms; (NB: different hardware platform may have a different duration for 1 jiffy)
The interface can be in one of two state, namely transmission state (Stateₜₓᵣₓ) or switching state (State_{switching})
Each state takes a duration (in units of jiffies) at least one jiffy
The application requests the transmission of an RTP packet right before the state is switched to State_{switching}.
The application requests the transmission of an RTP packet a little more than 20 ms after spending one jiffy in Stateₜₓᵣₓ.
An incoming RTP packet is queued at the AP right after the first interface has gone into State_{switching}, and
The decision to make on the next state comes just before the queuing of a outgoing RTP packet.

Based on FIG. 8 the theoretical maximum delay for incoming packets will be around 70 ms to 80 ms. The worst case jitter introduced by the switching between two virtual interfaces is therefore, say, 80 ms. If both UAs (i.e. phone 100 and other user 150) are roaming the worst case end-to-end jitter will be 160 ms. Therefore during roaming the jitter buffer should be set to at least 160 ms to prevent jitter in the conversation. To alleviate these extra delays the jitter buffer should be dynamic and adaptive. The delay is adjusted based on the roaming status. Normally the jitter is set from 20 ms to 40 ms in a Wi-Fi connection for smooth playback. If the phone 100 decides to roam to another AP, the phone adjusts its jitter buffer size to 160 ms and plays the RTP packets slower. Because the creation and setting up of the virtual interface (WEP, WPA, DHCP, STUN, TURN) takes some times (normally over 2 seconds) the playback of audio/video data at a slower speed will be undistinguished. After the roaming is done the jitter buffer plays the RTP packets faster to restore to the normal value.

One problem not addressed yet is firewalls. If the phones 100 150 are in private subnets the are probably behind a firewall or NAT server. For a standard stateless SIP proxy server a STUN or TURN server can be used to tackle the NAT problem.

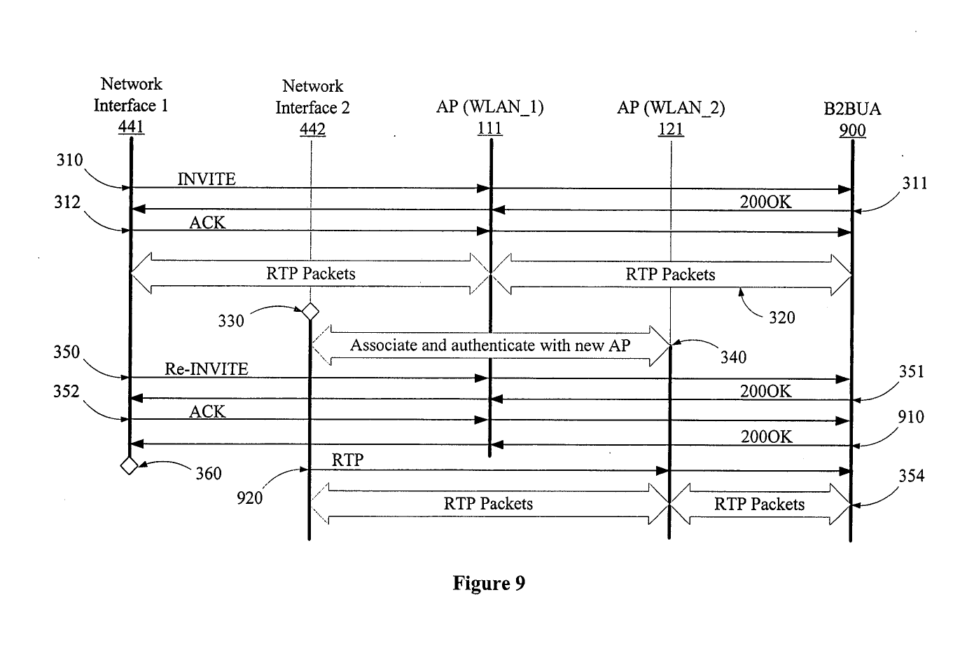

Another solution is to use a Back-to-Back User Agent (B2BUA) for NAT traversal. A B2BUA receives and processes INVITE messages as a User Agent Server (UAS) as well as acts as a User Agent Client (UAC) to determine how the request should be answered and how to initiate the outbound call. Most SIP service providers use a B2BUA instead of statefull or stateless SIP proxy server. Unlike a SIP proxy server the B2BUA maintains complete call state and participates in all call requests. FIG. 9 illustrates packet flow using a B2BUA. Because there are many B2BUAs (e.g. SER, Asterisk) and some of them are proprietary, we take VONAGE and sipphone.com as our testing service provider. VONAGE and sipphone.com are the largest SIP service providers in the USA. Roaming with B2BUA 900 is similar to that with a standard SIP proxy, illustrated in FIG. 3, except the behaviour of the first RTP packet after the re-INVITE. The VONAGE server, for example, will not send RTP packets to the new interface 442 after receiving re-INVITE. Instead, it keeps sending RTP packets to the old interface 441. Once the B2BUA 900 receives the first RTP packet 920 from the new interface 442 it will forward future RTP packet 354 to the new interface 442. This is also called “Symmetric RTP”. If the B2BUA 900 does not receive any packet from the new interface within 30 seconds after sending a 200 OK to the re-INVITE it will stop the RTP stream to the caller.

It should be appreciated that modifications and alternations obvious to those skilled in the art are not to be considered as beyond the scope of the present invention. For example, those skilled in the art will recognise that other methods of establishing multiple wireless network connections using a single wireless interface adapter have been proposed and may find application in the invention.

What is claimed is:

1. A method in a portable device having a single wireless network interface adaptor of roaming between access points on the same or different wireless networks while maintaining real-time IP data transfer with another device, the method comprising:
when connected with a first wireless network access point for real-time IP data transfer with another device, establishing a connection with a second wireless network access point such that the portable device can concurrently communicate with the first and second wireless access points for relocating the real-time IP data transfer to the second access point, and
switching between the first and second network access points for concurrently sending and receiving data packets via both access points using a switching strategy based at least in part on a number of the data packets to be send to each network access point.

2. The method of claim 1 wherein the switching strategy is based on a weighting scheme wherein the access point currently handling the real-time IP data transfer is allocated a first active time period and the other access point is allocated a second active time period shorter than the first active time period.

3. The method of claim 2 wherein the first active time period is between 60 and 100 milliseconds.

4. The method of claim 2 wherein the second active time period is between 10 and 40 milliseconds.

5. The method of claim 1 wherein the switching strategy is based at least in part on a number of packets buffered within the portable device for sending to each network access point.

6. The method of claim 5 wherein the switching strategy comprises switching to one of the network access points after a first switching time when there is a packet buffered for sending to that access point, and when no packet is buffered for sending to that access point switching to that access point after a second switching time that is longer than the first switching time.

7. The method of claim 6 wherein the first switching time is between 10 and 40 milliseconds.

8. The method of claim 6 wherein the second switching time is between 60 and 100 milliseconds.

9. The method of claim 1 wherein the switching strategy comprises before switching away from one of the network access points sending a first message to that network access point indicating that the portable device wireless network interface adaptor has entered a power save mode, and after a switching time switching back to that network access point and sending a second message requesting that any packets buffered by that access point be sent.

10. The method of claim 9 wherein the switching time is based at least in part on packets buffered within the portable device for sending to that access point.

11. The method of claim 9 wherein the switching time comprises a first switching time and a second switching time longer than the first switching time, and wherein the switching strategy further comprises switching back to that network access point after the first switching time when there is a packet buffered in the portable device for sending to that access point, and when no packet is buffered in the portable device for sending to that access point switching back after the second switching time.

12. The method of claim 11 wherein the first switching time is between 10 and 40 milliseconds.

13. The method of claim 11 wherein the second switching time is between 60 and 100 milliseconds.

14. The method of claim 9 wherein the first message is an IEEE 802.11 power save message.

15. The method of claim 9 wherein the second message is an IEEE 802.11 standard poll message.

16. A method in a portable device having a single wireless network interface adaptor of roaming between access points on the same or different wireless networks while maintaining real-time IP data transfer with another device, the method comprising:
receiving a beacon signal from a first wireless network access point with which the portable device has established a first connection for real-time IP data transfer with the other device,
determining whether to search for a second wireless network access point with which to established a second connection based at least in part on a condition, and
when it is determined to search for a second wireless network access point, probing each wireless radio channel separately to locate wireless network access points on the probed channel and between each probe allowing the portable device to send and receive packets to/from the other device.

17. The method of claim 16 wherein the condition includes at least the beacon signal strength falling below a threshold.

18. The method of claim 17 wherein the threshold is −80 dbm.

19. The method of claim 16 further comprising creating a list of located wireless network access points on each channel and after all wireless radio channels have been probed selecting from the list a second wireless network access point with which to established a second connection based at least in part on a second condition.

20. The method of claim 19 wherein the second condition is the access point having the highest signal strength that is also higher than the beacon signal strength of the first access point.

21. The method of claim 16 further comprising establishing a connection with the second wireless network access point such that the portable device can concurrently communicate with the first and second access points for relocating a real-time IP data transfer path from the first access point to the second access point, and when the real-time IP data path is relocated disconnecting from the first wireless network access point.

22. The method of claim 21 further comprising increasing the size of a data buffer in the portable device while the device is concurrently communicating with the first and second wireless access points.

23. The method of claim 21 further comprising switching between the first and second network access points using a dynamic switching strategy.

24. The method of claim 23 wherein the switching strategy is based at least in part on the number of packets to be send via each network access point.

25. The method of claim 23 wherein the switching strategy is based at least in part on the time spent on one of the access points after a packet is to be send via the other access point.

26. The method of claim 24 wherein the switching strategy comprises switching to the other access points after a first switching time when there is a packet buffered for sending to the other access point, and when no packet is buffered for sending to the other access point switching to the other access point after a second switching time that is longer than the first switching time.

27. The method of claim 26 wherein the first switching time is between 10 and 40 milliseconds.

28. The method of claim 26 wherein the second switching time is between 60 and 100 milliseconds.

29. A method in a portable device having a single wireless network interface adaptor of roaming between access points on the same or different wireless networks while maintaining real-time IP data transfer with another device, the method comprising:
providing a data buffer for storing received data during playback in the portable device and while connected with a first wireless network access point for real-time IP data transfer with another device:
making a decision to switch to a second wireless network access point for relocating the real-time IP data transfer to the second access point,
increasing a size of the buffer,
establishing a connection with the second wireless network access point such that the portable device can concurrently communicate with the first and second wireless access points,
switching between the first and second network access points for concurrently sending and receiving packets via both access points using a switching strategy based at least in part on a number of packets to be send to each access point,
relocating the real-time IP data transfer to the second access point, and
after the real-time IP data transfer is relocated to the second access point, disconnecting from the first wireless network access point and decreasing the size of the buffer.

30. The method of claim 29 further comprising, when increasing the size of the buffer also decreasing a speed of playback of the data, and when decreasing the size of the buffer also increasing the speed of playback of the data.

31. The method of claim 29 wherein making the decision to switch to the second wireless network access point comprises:
receiving a beacon signal from a first wireless network access point,
determining whether to search for a second wireless network access point with which to established a second connection based at least in part on the beacon signal strength,
when it is determined to search for a second wireless network access point, probing each wireless radio channel separately to locate wireless network access points on the probed channel and between each probe allowing the portable device to send and receive packets to/from the other device,
creating a list of located wireless network access points on each channel, and
selecting from the list a second wireless network access point with which to established a second connection based at least in part on which located access point has the highest signal strength that is also higher than the beacon signal strength of the first access point.

32. The method of claim 29 wherein the switching strategy comprises switching to one of the network access points after a first switching time when there is a packet buffered for sending to that access point, and when no packet is buffered for sending to that access point switching to that access point after a second switching time that longer than the first switching time.

33. The method of claim 32 wherein the first switching time is between 10 and 40 milliseconds.

34. The method of claim 32 wherein the second switching time is between 60 and 100 milliseconds.

35. A method in a portable device having a single wireless network adapter of simultaneously associating with two wireless network access points, the method comprising:
providing in the device an adapter driver for controlling the wireless network adapter,
maintaining a list of association parameters for at least a first and a second wireless network access point with which the portable device is associated,
determining a switching schedule for switching between the first and second wireless network access points, and
switching between the first and second network access points according to the schedule, wherein a power save message is sent to one of the first or second network access points and association parameters from the list are loaded to the adapter driver for connection with the other one of the first or second network access points.

36. A portable device for engaging in real-time IP data transfer with another device over a network, the device having a single wireless network interface adaptor and at least one electronic storage medium having machine readable instructions thereon permitting the device to perform steps of:
connecting with a first wireless network access point for real-time IP data transfer with another device,
establishing a connection with a second wireless network access point such that the portable device can concurrently communicate with the first and second wireless access points for relocating the real-time IP data transfer to the second access point, and
switching between the first and second network access points for concurrently sending and receiving data packets via both access points using a switching strategy based at least in part on a number of the data packets to be send to each network access point.

37. The portable device of claim 36 wherein the switching strategy is based on a weighting scheme wherein the access point currently handling the real-time IP data transfer is allocated a first active time period and the other access point is allocated a second active time period shorter than the first active time period.

38. The portable device of claim 37 wherein the first active time period is between 60 and 100 milliseconds.

39. The portable device of claim 37 wherein the second active time period is between 10 and 40 milliseconds.

40. The portable device of claim 36 wherein the switching strategy is based at least in part on a number of packets buffered within the portable device for sending to each network access point.

41. The portable device of claim 40 wherein the switching strategy comprises switching to one of the network access points after a first switching time when there is a packet buffered for sending to that access point, and when no packet is buffered for sending to that access point switching to that access point after a second switching time that is longer than the first switching time.

42. The portable device of claim 41 wherein the first switching time is between 10 and 40 milliseconds.

43. The portable device of claim 41 wherein the second switching time is between 60 and 100 milliseconds.

44. The portable device of claim 36 wherein the switching strategy comprises before switching away from one of the network access points sending a first message to that network access point indicating that the wireless network interface adaptor has entered a power save mode, and after a switching time switching back to that network access point and sending a second message requesting that any packets buffered by that access point be sent.

45. The portable device of claim 44 wherein the switching time is based at least in part on packets buffered within the portable device for sending to that access point.

46. The portable device of claim 44 wherein the switching time comprises a first switching time and a second switching time longer than the first switching time, and wherein the switching strategy further comprises switching back to that network access point after the first switching time when there is a packet buffered in the portable device for sending to that access point, and when no packet is buffered in the portable device for sending to that access point switching back after the second switching time.

47. The portable device of claim 46 wherein the first switching time is between 10 and 40 milliseconds.

48. The portable device of claim 46 wherein the second switching time is between 60 and 100 milliseconds.

49. The portable device of claim 44 wherein the first message is an IEEE 802.11 power save message.

50. The portable device of claim 44 wherein the second message is an IEEE 802.11 standard poll message.

51. The portable device of claim 36 which is a wireless IP phone.

52. A portable device for engaging in real-time IP data transfer with another device over a network, the device having a single wireless network interface adaptor and at least one electronic storage medium having machine readable instructions thereon permitting the device to perform steps of:
receiving a beacon signal from a first wireless network access point with which the portable device has established a first connection for real-time IP data transfer with the other device,
determining whether to search for a second wireless network access point with which to established a second connection based at least in part on a condition, and
when it is determined to search for a second wireless network access point, probing each wireless radio channel separately to locate wireless network access points on the probed channel and between each probe allowing the portable device to send and receive packets to/from the other device.

53. The portable device of claim 52 wherein the condition includes at least the beacon signal strength falling below a threshold.

54. The portable device of claim 53 wherein the threshold is −80 dbm.

55. The portable device of claim 52 further comprising machine readable instructions permitting the device to perform steps of creating a list of located wireless network access points on each channel and after all wireless radio channels have been probed selecting from the list a second wireless network access point with which to established a second connection based at least in part on a second condition.

56. The portable device of claim 55 wherein the second condition is the access point having the highest signal strength that is also higher than the beacon signal strength of the first access point.

57. The portable device of claim 52 further comprising machine readable instructions permitting the device to perform steps of establishing a connection with the second wireless network access point such that the portable device can concurrently communicate with the first and second access points for relocating a real-time IP data transfer path from the first access point to the second access point, and when the real-time IP data path is relocated disconnecting from the first wireless network access point.

58. The portable device of claim 57 further comprising a data buffer and machine readable instructions permitting the device to perform steps of increasing the size of the data buffer while the device is concurrently communicating with the first and second wireless access points.

59. The portable device of claim 57 further comprising machine readable instructions permitting the device to perform steps of switching between the first and second network access points using a dynamic switching strategy.

60. The portable device of claim 59 wherein the switching strategy is based at least in part on the number of packets to be send via each network access point.

61. The portable device of claim 59 wherein the switching strategy is based at least in part on the time spent on one of the access points after a packet is to be send via the other access point.

62. The portable device of claim 60 wherein the switching strategy comprises switching to the other access points after a first switching time when there is a packet buffered for sending to the other access point, and when no packet is buffered for sending to the other access point switching to the other access point after a second switching time that is longer than the first switching time.

63. The portable device of claim 62 wherein the first switching time is between 10 and 40 milliseconds.

64. The portable device of claim 62 wherein the second switching time is between 60 and 100 milliseconds.

65. The portable device of claim 52 which is a wireless IP phone.

66. A portable device for engaging in real-time IP data transfer with another device over a network, the device having a single wireless network interface adaptor, and at least one electronic storage medium having a data buffer for storing received data during playback and machine readable instructions thereon permitting the device to perform steps of:
connecting with a first wireless network access point for real-time IP data transfer with another device
making a decision to roam to a second wireless network access point for relocating the real-time IP data transfer to the second access point,
increasing a size of the buffer,
establishing a connection with the second wireless network access point such that the portable device can concurrently communicate with the first and second wireless access points,
switching between the first and second network access points for concurrently sending and receiving packets via both access points using a switching strategy based at least in part on a number of packets to be send to each access point,
relocating the real-time IP data transfer to the second access point, and
after the real-time IP data transfer is relocated to the second access point, disconnecting from the first wireless network access point and decreasing the size of the buffer.

67. The portable device of claim 66 further comprising machine readable instructions permitting the device to perform steps of decreasing a speed of playback of the data when increasing the size of the buffer, and increasing the speed of playback of the data when decreasing the size of the buffer.

68. The portable device of claim 66 wherein making the decision to roam to the second wireless network access point comprises:
receiving a beacon signal from a first wireless network access point,
determining whether to search for a second wireless network access point with which to established a second connection based at least in part on the beacon signal strength,
when it is determined to search for a second wireless network access point, probing each wireless radio channel separately to locate wireless network access points on the probed channel and between each probe allowing the portable device to send and receive packets to/from the other device,
creating a list of located wireless network access points on each channel, and
selecting from the list a second wireless network access point with which to established a second connection based at least in part on which located access point has the highest signal strength that is also higher than the beacon signal strength of the first access point.

69. The portable device of claim 66 wherein the switching strategy comprises switching to one of the network access points after a first switching time when there is a packet buffered for sending to that access point, and when no packet is buffered for sending to that access point switching to that access point after a second switching time that longer than the first switching time.

70. The portable device of claim 69 wherein the first switching time is between 10 and 40 milliseconds.

71. The portable device of claim 69 wherein the second switching time is between 60 and 100 milliseconds.

72. The portable device of claim 66 which is a wireless IP phone.

73. A method in a portable device having a single wireless network interface adaptor of roaming between access points on the same or different wireless networks while maintaining real-time IP data transfer with another device, the method comprising:
when connected with a first wireless access point on a first wireless network scanning wireless radio channels to locate a second wireless access point with which to established a second connection, and
upon locating a second wireless access point determining if the second wireless access point is on the first wireless network or another wireless network, said determining step comprising sending a digital communications packet to the second wireless access point and waiting for a response to the sent communications packet from the second wireless access point, wherein the packet has as its immediate destination the first wireless access point and as its final destination the second wireless access point.

74. The method of claim 73 wherein, if a response to the sent communications packet is received from the second wireless access point then roaming from the first wireless access point to the second wireless access point.

75. The method of claim 73 further comprising creating a list of located wireless access points on each channel and after all wireless radio channels have been scanned determining for each located wireless access point if that wireless access point is on the first wireless network or another wireless network, and selecting from the list the second wireless access point with which to established a second connection based at least in part on a condition.

76. The method of claim 75 wherein the condition is an access point on the first wireless network and having the highest signal strength that is also higher than the signal strength of the first access point.

77. The method of claim 76 wherein if none of the located wireless access points fulfil the condition then selecting as the second wireless access point the access point having the highest signal strength that is also higher than the signal strength of the first access point and undertaking the method of any one of claims 1 to 15.
